(19) United States
(12) Patent Application Publication
(10) Pub. No.: US 2008/0304611 A1
(43) Pub. Date: Dec. 11, 2008

(54) Electricity generation from nuclear fusion

(76) Inventor: Kuai-Teng Hsu, Clarksville, MD (US)

Correspondence Address: Kuai-Teng Hsu, 7371 Hallmark Road, Clarksville, MD, 21029, US

(21) Appl. No.: 11/810,683

(22) Filed: Jun. 7, 2007

(51) Int. Cl. G21B 1/21

(52) U.S. Cl. 376/100

(57) ABSTRACT

A method, using the reaction between Lithium and neutron to produce Tritium, is used to sustain Deuterium-Tritium nuclear fusion long enough to produce electrical power.

This method uses Deuterium-Tritium nuclear fusion to produce energy. The energy produced by Deuterium-Tritium nuclear fusion is used to heat water to produce steam. The steam produced is used to operate steam turbine. The steam turbine operates electrical generator to produce electricity. The electricity generated is used as electrical power.

In the Deuterium-Tritium nuclear fusion, Deuterium is naturally abundant, but Tritium is naturally scarce.

This invention provides a method to supply Tritium. That is, Lithium, which is naturally abundant, is added as fuel. The neutron produced by Deuterium-Tritium nuclear fusion will react with Lithium to produce Tritium. Thus it sustains the Deuterium-Tritium nuclear fusion long enough to produce fusion energy, which is then turned into electrical power.

### BACKGROUND OF PRESENT INVENTION

1. Field of Invention

The present invention relates to a method, and more particularly a new method to produce electricity from nuclear fusion.

2. Description of Related Arts

### Electrical Generator

An electrical generator is a device that converts mechanical energy to electrical energy. The sources of mechanical energy are: steam turbine; water falling through a turbine or waterwheel; wind turbine or any other source of mechanical energy.

### Steam Turbine

Steam turbine is device widely used for generating electricity. It makes use of the energy existed in steam, converts it to mechanical energy, and then converts it to electrical energy.

### Sources of Steam

Conventional power plants burn coal or oil to heat water to produce steam. Nuclear power plants use fission energy to heat water to produce steam. The steam are then used by steam turbine to produce electricity.

### Nuclear Fusion

Nuclear fusion is the process by which multiple nuclei join together to form a heavier nucleus. It is accompanied by the release of energy. The energy released in this process is much greater than that in chemical reaction, because the biding energy that hold nucleus together is far greater than the energy that holds electrons to a nucleus.

### Deuterium-Tritium Nuclear Fusion

Both Deuterium (atomic symbol D) and Tritium (atomic symbol T) are the isotopes of Hydrogen (atomic symbol H). The nuclear fusion of Deuterium and Tritium atoms produces Helium atom (atomic symbol ⁴He) and one neutron (atomic symbol n), and 17.6 Mev of energy, as shown in equation below.

D+T→⁴He+n+17.6 Mev

This is considered the most promising for producing fusion power.

### Clean Energy

The Helium and neutron produced by Deuterium-Tritium nuclear fusion are stable. They would not decay, so there is no radiation associated with this reaction. The energy produced by this reaction is clean energy.

### Plasma

Plasma is an ionized gas. “Ionized” means that at least one electron has been dissociated from, or added to, the atoms or molecules. The free electric charges make the plasma electrically conductive so that it responds strongly to electromagnetic fields.

### Coulomb Barrier

Fusion between the atoms is being opposed by their electrical charge, specifically the net positive charge of the nuclei. This electrostatic force to oppose fusion is called “Coulomb Barrier”. In order to overcome this barrier, external energy must be supplied. The easiest way is to heat atoms, which has the side effect of stripping the electrons from the atoms and leaving them in the form of plasma. The temperature required to provide the nuclei with enough energy to overcome the Coulomb Barrier is a function of their total charge. Hydrogen, which has the smallest nuclear charge, reacts at the lowest temperature. So the Deuterium-Tritium fusion reacts at the lowest temperature in all nuclear fusions. However, even at the lowest temperature, all the nuclei in Deuterium-Tritium nuclear fusion are in the form of plasma.

### Magnetic Confinement of Nuclear Fusion

To produce self-sustaining nuclear fusion, the energy released by the reaction, or portion of it, must be used to heat new reactant nuclei and keep them hot long enough so that they also undergo fusion reactions. Retaining the heat is called energy confinement.

At the temperature required for fusion, the fuel are in the form of plasma, which has very good electrical conductivity. This leads to the method to confine the fuel and energy with magnetic fields, an idea known as magnetic confinement.

### Toroidal Surfaces

In magnetic confinement, the way to prevent the plasma from leaking out of the ends of the magnetic field lines is to bends the magnetic fields lines back on themselves in nested toroidal surfaces.

### Fusion Power

Fusion power refers to the power generated by nuclear fusion process. To produce fusion power, the energy produced by Deuterium-Tritium nuclear fusion is used to heat water to generate steam. The steam generated is then used to operate steam turbine. Then, the steam turbine operates electrical generator to generate electricity. The electricity generated is then used as electrical power.

### Scarcity of Tritium

In the Deuterium-Tritium nuclear fusion, Deuterium is a naturally-occurring isotope of hydrogen and is universally available. Tritium is also an isotope of hydrogen, but it occurs naturally only in negligible amounts due to its radioactive half-life of 12.34 years. The scarcity of tritium is the problem to sustain Deuterium-Tritium nuclear fusion.

### SUMMARY OF THE PRESENT INVENTION

The main object of the present invention is to provide a method, using the reaction between Lithium and neutron to produce Tritium, to sustain Deuterium-Tritium nuclear fusion long enough to produce fusion energy which is then turned into electrical power.

Another object of the present invention is to use Deuterium-Tritium nuclear fusion to produce energy.

Another object of the present invention is to utilize the energy produced by Deuterium-Tritium nuclear fusion to heat water to produce steam.

Another object of the present invention is to use the steam produced by Deuterium-Tritium nuclear fusion to operate steam turbine.

Another object of the present invention is to use the steam turbine to operate electrical generator to produce electricity.

Another object of the present invention is to use the electricity generated as electrical power.

Another object of the present invention is to supply Tritium, because in the Deuterium-Tritium nuclear fusion, Deuterium is naturally abundant, but Tritium is naturally scarce.

Another object of the present invention is to add Lithium, which is naturally abundant, as fuel. The neutron produced by Deuterium-Tritium nuclear fusion will react with Lithium to produce Tritium. Thus it sustains the Deuterium-Tritium nuclear fusion long enough to produce fusion energy which is then turned into electrical power.

### BRIEF DESCRIPTION OF THE DRAWING

None

### DETAILED DESCRIPTION OF THE PREFERRED EMBODIMENT

It is well-known that the nuclear fusion of Deuterium atom (atomic symbol D) and Tritium atom (atomic symbol T) produces Helium atom (atomic symbol ⁴He) and one neutron (atomic symbol n), and 17.6 Mev of energy, as shown in equation below.

D+T→⁴He+n+17.6 Mev

This is considered the most promising for producing fusion power.

To produce fusion power, the energy produced by Deuterium-Tritium nuclear fusion is used to heat water to generate steam. The steam generated is then used to operate steam turbine. Then, the steam turbine operates electrical generator to generate electricity. The electricity generated is then used as electrical power.

The Helium and neutron produced by Deuterium-Tritium nuclear fusion are stable. They would not decay, so there is no radiation associated with this reaction. The energy produced by this reaction is clean energy.

To use Deuterium-Tritium nuclear fusion for fusion power, the Deuterium-Tritium nuclear fusion must be sustained long enough to produce enough energy. However, there is problem associated with this sustainability. That is, Deuterium is naturally abundant, but Tritium is naturally scarce. This causes a problem to sustain Deuterium-Tritium nuclear fusion because the lack of Tritium in the fuel.

This invention provides a method to supply Tritium during the Deuterium-Tritium nuclear fusion. Thus the fusion process can be sustained long enough to produce power.

In this method, Lithium (atomic symbol Li), which is naturally abundant, is added as fuel. The neutron produced by Deuterium-Tritium nuclear fusion will react with Lithium to produce Tritium, as described in the following equations

n+⁶Li→T+⁴He

n+⁷Li→T+⁴He+n

With this invention, Deuterium-Tritium nuclear fusion process can be sustained long enough to produce fusion energy which is then turned into electrical power.

What is claimed is:

1. A method, using the reaction between Lithium and neutron to produce Tritium, to sustain Deuterium-Tritium nuclear fusion long enough to produce fusion energy which is then turned into electrical power, as described below:
a. This method uses Deuterium-Tritium nuclear fusion to produce energy.
b. The energy produced by Deuterium-Tritium nuclear fusion is used to heat water to produce steam.
c. The steam produced is used to operate steam turbine.
d. The steam turbine operates electrical generator to produce electricity.
e. The electricity generated is used as electrical power.
f. In the Deuterium-Tritium nuclear fusion, Deuterium is naturally abundant, but Tritium is naturally scarce.
g. This invention provides a method to supply Tritium. That is, Lithium, which is naturally abundant, is added as fuel. The neutron produced by Deuterium-Tritium nuclear fusion will react with Lithium to produce Tritium. Thus it sustains the Deuterium-Tritium nuclear fusion long enough to produce fusion energy which is then turned into electrical power.
